(19) United States
(12) Patent Application Publication
(10) Pub. No.: US 2006/0144961 A1
(43) Pub. Date: Jul. 6, 2006

(54) Pressure washer

(76) Inventors: Kathy DeKeyser, Jackson, TN (US); William Burnett, Menlo Park, CA (US); John Larkin, Santa Clara, CA (US); John Johnston, Redwood City, CA (US); Jennifer A. Schlee, Sunnyvale, CA (US); Brian Lamb, Menlo Park, CA (US); Kathy Hannon Davies, Fremont, CA (US)

Correspondence Address: THE BLACK & DECKER CORPORATION, 701 EAST JOPPA ROAD, TW199, TOWSON, MD, 21286, US

(21) Appl. No.: 10/951,342

(22) Filed: Sep. 27, 2004

Related U.S. Application Data
(60) Provisional application No. 60/506,008, filed on Sep. 25, 2003.

(51) Int. Cl. B05B 7/04

(52) U.S. Cl. 239/398; 239/302

(57) ABSTRACT

A pressure washer is provided including the capability of interchangeably connecting a plurality of cartridges containing various additives for the application of the additives within a high pressure water stream. The pressure washer includes a gun which includes a cartridge receiver capable of connecting, one at a time, the plurality of cartridges and allowing for the additive to be included within the high pressure water stream.

### CROSS REFERENCE TO RELATED APPLICATION

The current application claims priority under 35 U.S.C. §119(e) to the U.S. Provisional Application Ser. No. 60/506,008, filed on Sep. 25, 2003, which is herein incorporated by reference in its entirety.

### FIELD OF THE INVENTION

The present invention generally relates to the field of hydraulic devices such as pressure washers, water jets, and the like that are capable of delivering a fluid from a supply source and discharging it under pressure, and more particularly, to apparatus, systems, and methods of utilizing these hydraulic devices.

### BACKGROUND OF THE INVENTION

The use of hydraulic fluids, i.e., water, oils, air, for devices which create and use highly pressurized streams of fluid to accomplish a task is commonplace. For instance, a pressure washer or water jet deliver a highly pressurized fluid stream to a surface to be cleaned, stripped, or prepared for treatment. Alternatively, these devices may deliver a highly pressurized fluid stream to lifting mechanisms, digging mechanisms, or for recreational purposes. As such, hydraulic devices, such as pressure washers and water jets, are produced in numerous design configurations and can be used to perform a variety of tasks whether in a home, commercial, or industrial setting.

These devices are powered by a power source which drives the pump to which a directional controlling device, such as a spray wand of gun, may be coupled via a length of hose. Typically, the power source is either an electric motor or combustion engine. Whether the high pressure device is a portable device or a stationary device will determine the size of the engine and therefore the power of the pump to pressurize the fluid stream. In the industrial and/or commercial settings the devices are generally stationary which accommodates larger engine and pump size, that have the ability to create a larger stream, i.e., greater capacity, higher pressure, of pressurized fluid. For example, car washes, hydraulic lifts, and the like, will employ stationary hydraulic devices to move large volumes of water or overcome significant weight resistance.

Unfortunately, most of these devices, such as the pressure washers and water jets, have been limited in their application. Therefore, it would be desirable to provide hydraulic devices which may be used in a wider variety of settings to accomplish a greater number of tasks.

### SUMMARY OF THE INVENTION

Accordingly the present invention provides hydraulic devices, such as pressure washers and water jets, which allow an operator to accomplish a greater number of tasks in various settings. It is an object of the present invention to provide a high pressure cleaning system for cleaning or un-clogging confined spaces, such as in pipes containing flow restrictions. Such a system may employ various devices connected with a pump of a pressure washer/water jet, such as a high pressure nozzle which utilizes a stream of high pressure fluid to clear the flow restriction. Alternatively, the system may employ a high pressure blade attachment connected with the pump which may clear a flow restriction utilizing a spinning blade.

It is another object of the present invention to provide a gun connected with a pressure washer/water jet that is capable of including various additives to the fluid stream being expelled from the gun. The gun includes a cartridge receiver within which various cartridges may be interchangeably loaded and unloaded. These various cartridges may contain numerous different additives, such as soap, grit for abrasion, air for drying, primer, wood treatment, paint, sealant, and the like which may be expelled from the gun along with the fluid.

A further object of the present invention is to provide a marine cleaning system which employs a pressure washer/water jet to clean various surfaces which are exposed to marine environments. The marine cleaning system may assist in prolonging the useful lifespan of various devices which have surfaces exposed to the marine environment. For example, a the hull of a boat or other watercraft need to have those surfaces which are exposed to the water cleaned in order to prevent the accumulation of aquatic growth, such as barnacles, etc., or other harmful materials on those surfaces. The marine cleaning system may include various additional features, such as a sail cleaning assembly, bilge pump assembly, line cutter assembly, water recycling unit, and the like.

It is an additional object of the present invention to provide a finishing tool system which is utilized for applying a finish to various workpieces. The finish applications may include forming multiple levels/layers in a workpiece, the addition of various sealants, paints, lacquers, and the like, or the constructing of various patterns in workpieces.

A gardening system and sprinkler installation system are further contemplated by the present invention. The gardening system providing for various capabilities, such as the construction of a garden by constructing rows and the planting of seeds. Lawn aeration and snow removal is another capability of the present invention. The gardening system may include a seed gun for the planting/application of seeds or it is contemplated that the seed gun may be separate from the gardening system. The sprinkler installation system provides for trenching through various surfaces and sub-surfaces in order to allow for the placement of the necessary piping/tubing and sprinkler heads which may be required by a sprinkler system.

In still further embodiments of the pressure washer/water jet of the present invention provides a hydraulic lift system. The hydraulic lift system may be employed to raise and lower various heavy items, such as a car, motorcycle, and the like, which may be difficult to raise and lower without mechanical assistance.

It is a further object of the pressure washer/water jet of the present invention to provide a composting device. The composting device capable of composting organic matter. The compost may be utilized in gardens or as fill. The composting device may be included in the gardening system mentioned above.

It is another object of the pressure washer/water jet of the present invention to provide a cutting system which may be utilized to cut through various items. The cutting system may be employed to cut rope, fiberglass, wood, and the like, which are capable of being cut by a high pressure water stream. It is further contemplated that various boring activities and/or trenching activities, including those mentioned above, may be accomplished by the use of the present invention.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a high pressure pipe cleaning system including blade attachments in accordance with an exemplary embodiment of the present invention;

FIG. 2 is an illustration of a delicate cleaning system in accordance with an exemplary embodiment of the present invention;

FIG. 3 is an illustration of a marine cleaner system in accordance with an exemplary embodiment of the present invention;

FIG. 4 is an illustration of a multi-layer finishing tool system in accordance with an exemplary embodiment of the present invention;

FIG. 5 is an illustration of a composting assembly in accordance with an exemplary embodiment of the present invention;

FIG. 6 is an illustration of a misting system in accordance with an exemplary embodiment of the present invention;

FIG. 7 is an illustration of a law aeration and snow removal system in accordance with an exemplary embodiment of the present invention;

FIG. 8 is an illustration of a seed gun system in accordance with an exemplary embodiment of the present invention;

FIG. 9 is an illustration of a hose winder assembly in accordance with an exemplary embodiment of the present invention;

FIG. 10 is an illustration of a gardening assembly in accordance with an exemplary embodiment of the present invention;

FIG. 11 is an illustration of a modular cartridge hydraulic system in accordance with an exemplary embodiment of the present invention;

FIG. 12 is an illustration of a sprinkler installation system in accordance with an exemplary embodiment of the present invention; and

FIG. 13 is an illustration of a hydraulic lift assembly in accordance with an exemplary embodiment of the present invention.

### DETAILED DESCRIPTION OF THE INVENTION

Reference will now be made in detail to the presently preferred embodiments of the invention, examples of which are illustrated in the accompanying drawings. It is to be understood that the various embodiments shown may be configured as closed or open systems. In an open system, the pump produces a pressurized fluid stream which is expelled through various devices, such as a gun. The expelled pressurized fluid stream is utilized in the performance of a task, but the fluid utilized is lost. In a closed system, the pump produces a pressurized fluid stream which is expelled for use in the performance of a task, as described above. However, the expelled fluid is recaptured into a storage facility, such as a reservoir, which may then be re-used by the pump in providing the pressurized fluid stream. In alternative embodiments, the fluid may be directed into a secondary device for use in the performance of a task and then recaptured from the secondary device after completion of the task.

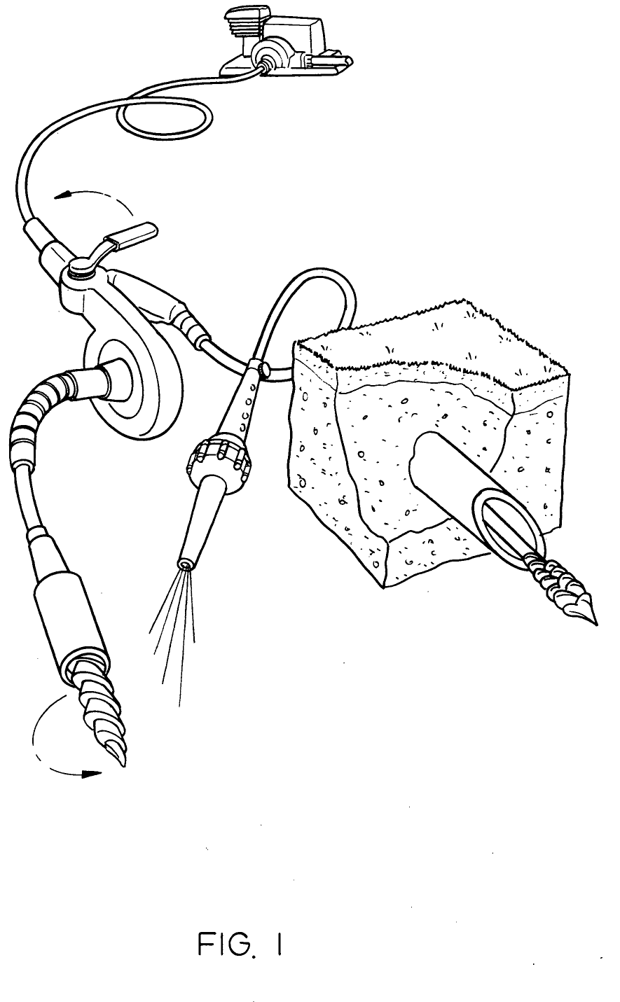

Referring generally now to FIGS. 1 through 3, exemplary embodiments of cleaning systems of the present invention are shown. In FIG. 1 a hydraulic pump system is shown enabled as a high pressure pipe cleaning system. The pipe cleaning system uses a high pressure fluid, such as water, to provide a tool which may be used to clean out confined areas. The confined areas may include pipes which have been clogged with debris. In one embodiment, the pipe cleaning system may employ a high pressure nozzle which may be fed into and/or down the pipe. The nozzle directs the stream of high pressure fluid towards the blockage, breaking the blockage apart and unclogging the pipe. In an alternative embodiment, the roto-rooter system may employ a high pressure blade attachment. The high pressure blade attachment may be fed into and/or down the pipe. The fluid fed into the high pressure blade attachment may impart angular momentum to the blade, the spinning blade may engage with the blockage and due to its high spin rate and cutting surfaces, cut the blockage apart and unclog the pipe.

The pipe cleaning system employs a power source, such as an electric engine, to provide power to a pump which drives the fluid through the system. Other components may include hoses, pipes, tubes, or other fluid delivery devices which may couple with the pump to deliver the fluid. Further, the fluid delivery devices may couple with the nozzle and high pressure blade attachment, thereby delivering the fluid to these devices. The high pressure blade attachment may be configured in a variety of ways, such as with a sheathed blade which extends upon engagement with the blockage, and may be of various shapes and sizes as contemplated by one of ordinary skill in the art. It is further contemplated that the pipe cleaning system may be enabled with a snake device in order to feed the nozzle, high pressure blade attachment, and other devices down into areas, such as the interior of a pipe, to enable engagement with the blockage.

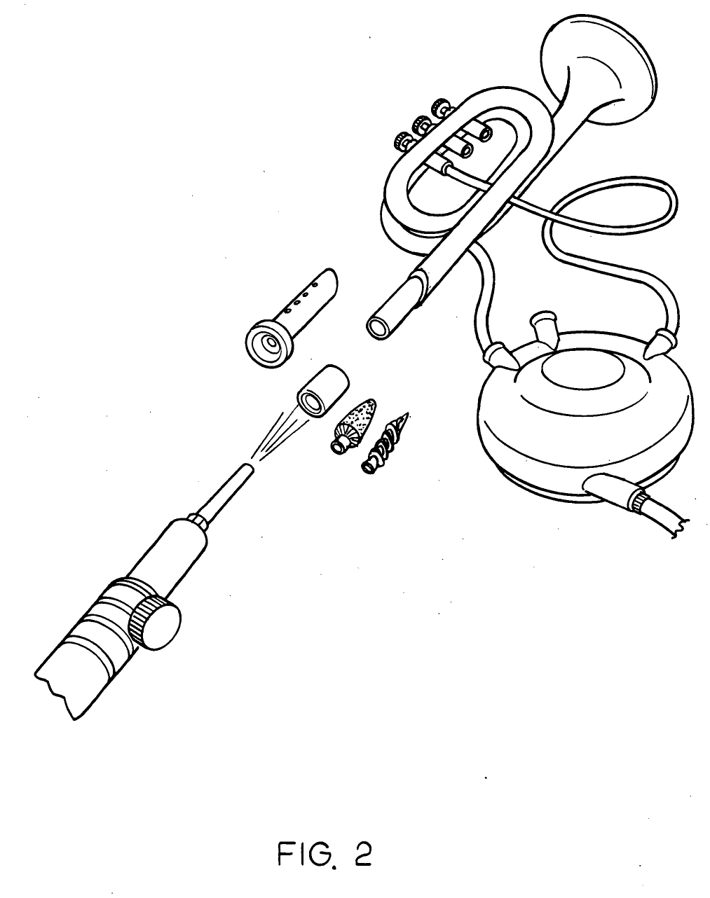

A delicate cleaning system is shown in FIG. 2. This system may be used to clean small or delicate objects, such as bike chains, jewelry, and the like. As in FIG. 1 an engine may be coupled with a pump to drive fluid through the system. The pump may use a variety of fluid delivery devices to deliver the fluid to delicate nozzles and plugs. The delicate cleaning system includes several attachments, such as nozzles, for external cleaning and internal cleaning, such as to clean the interior tubing of instruments, like the trumpet shown in FIG. 2. The various attachments may be differently sized and shaped for use in accomplishing specific tasks. It is further contemplated that the delicate cleaning system may be enabled as a snake device allowing for the delivery of the fluid stream through confined areas to reach a blockage or cleaning site.

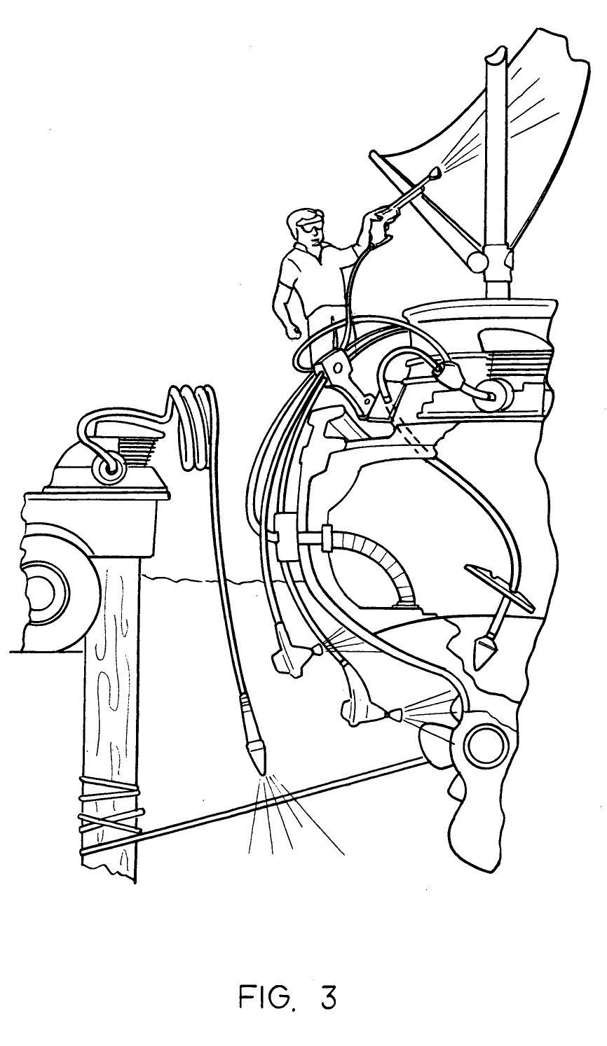

In a further embodiment, shown in FIG. 3, a marine cleaning system is shown. Maintenance of surfaces exposed to marine environments may be important in order to provide an aesthetically pleasing appearance and prolong the life of the surface. Further, by keeping these surfaces clean it may decrease drag on these surfaces, allowing the water to flow smoothly over these surfaces. Unfortunately, many times these surfaces are difficult to reach, this may result from the surfaces being at difficult to reach angles, under the waters surface or any assortment of issues which may arise. Thus, the marine cleaning system provides a user a way to clean those surfaces in marine environments. Similar to FIG. 1, an engine operationally coupled to a pump provides a driving force to a fluid within the marine cleaning system. The fluid is transferred through fluid delivery devices into a variety of marine cleaning devices. The marine cleaning devices, may include a deck cleaner/scrubber device for maintaining a boat deck. Further, a water recycling unit may be included to draw water from a variety of water sources for a variety of purposes, such as cleaning. A line cutter assembly may be coupled with the fluid delivery devices in order to provide a way to free entangled lines which have become caught in the propeller, rudder, or other parts of the boat. For cleaning below the surface of the water, the present embodiment may include an in-situ hull cleaner. Other features of the marine cleaning system may include a propeller turning attachment, which may assist in freeing entangled propellers, a bilge pump assembly, which may include bilge cleaning attachments, and a sail cleaning assembly for keeping sails clean.

In other alternative embodiments, cleaning systems use pressurized hydraulic liquids to drive a foam plug through pipes, cleaning the pipes and clearing clogs. Shower mold removal attachments kits may include grout removal attachments, which provide a concentrated water stream for deep scrubbing, and hot and cold options. Cleaning systems may also include a toilet tank cleaner and high pressure decarbonization systems. Systems may also include rot removal tools used to blast rot out, especially dead wood, termite infested wood, dry rot, rotted posts in cement enclosures. A workpiece chip remover/blower cleaning system keeps a work area clear so the user can see what they are working on. Chimney cleaning systems, employing various chimney cleaning attachments, may allow the user to safely clean the inside of a chimney and may include a specific water reclamation system so the user can blast the water up the chimney from inside, but not wet the inside of the house. Super heated water and high powered steam cleaning systems may be used on decks, stonework, etc. Alternative embodiments may include, oil removal systems, both for on land and in water oil slicks, and may be laid out in a circular fashion to surround and contain the slick for collection. Systems may also include industrial dish washers, assembly line style steam and water jets to clean the dishes, and gutter and brickwork cleaning systems.

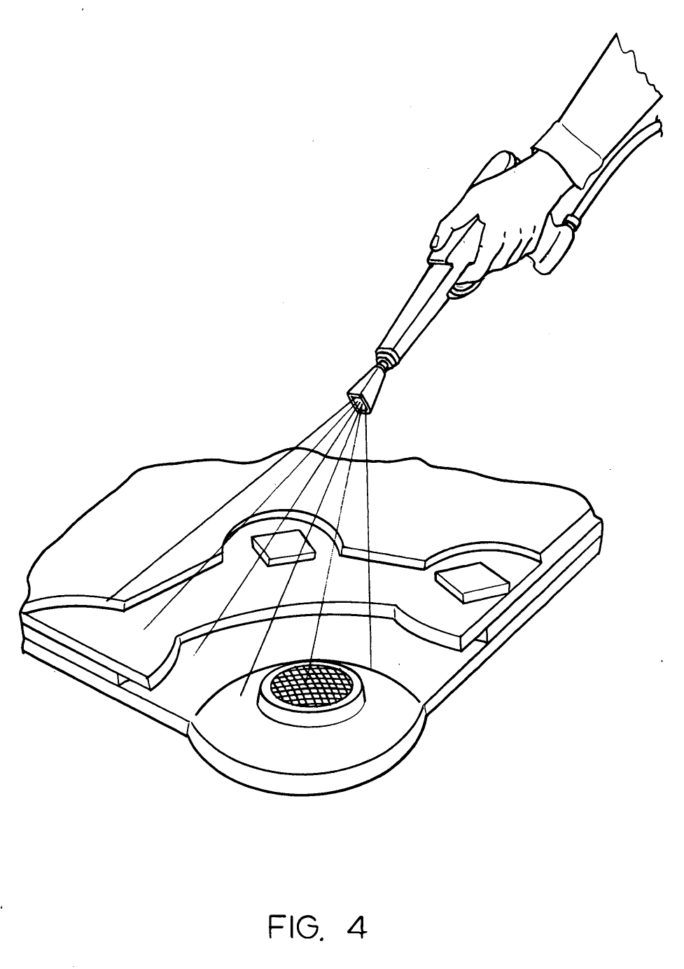

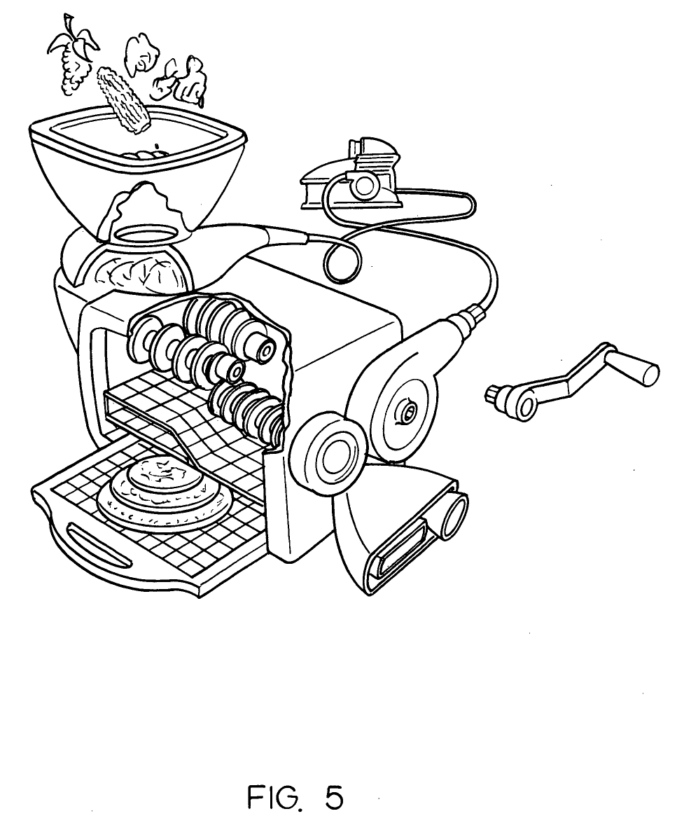

Referring generally now to FIGS. 4 and 5, exemplary embodiments of cutting or abrading systems of the present invention are shown.

In FIG. 4 a multi layer finishing tool system is shown, including a gun assembly coupled to a pump via a fluid delivery device. The pump is coupled with an engine to provide a power source to the system. In operation, through use of the gun assembly, the multi layer finishing tool system allows the user to scrape away different depths, creating designs, different colors and patterns. For instance, if a user of the present embodiment had stacked layers of different materials in an area, the present invention would allow the user to direct the removal of layers of material in any manner they select. As FIG. 4 exemplifies, one area may have several layers removed while other areas may have only one layer removed, or patterns may be established in the layers. The gun assembly may include a variety of nozzles and directional spouts for use with the system. It is contemplated, that template nozzles may be employed.

In an alternative embodiment, the present invention may be enabled as a compositing machine, as shown in FIG. 5. The user feeds yard waste into a compost bin, where it is fed through a series of chopping blades. The user may select to remove the dry ground material or to add water to create a slurry. As shown in this exemplary embodiment, the composting machine is in fluid communication with a fluid pump via a fluid delivery device and the fluid pump is coupled with an engine to provide power to drive the fluid through the pump and the fluid delivery device.

In other alternative embodiments, cutting or abrading systems may include insulation cutting systems, used to slice fiberglass insulation cleanly, keeping dust and glass particles to a minimum. Graffiti removal systems may employ attachments or tools which may be used to remove paint in the shape of the graffiti design. Deep hole drilling systems may have water that runs as coolant and chip remover through the hole from an attachment to a hand drill or drill press. The water is then collected by a vacuum attachment around the drill site. These systems may also employ high pressure water jet tools used to break up heavy or dense soils (like clay). Very powerful water pick systems allow the user to clean crevices and narrow spaces. Concrete demolition systems may employ tools and attachments which are used to break up slab or pavement. Water auger systems, driven by hydraulic power, allow the excess water to be used to loosen the oil as runoff. Post removal systems may employ a water jet to quickly erode and remove the wood of the posts, leaving the concrete slab in place. For example, when a wood post, encased in concrete, has rotted the post removal system may be employed to remove the rotted wood post but leave the concrete in place. Cutting or abrading systems may further include under water table saws. Water drill systems use a high speed stream of water to punch holes in the work piece, instead of a mechanical drill. Polishing or tumbling systems allow the user to create a surface treatment on finished parts of a workpiece. This may be primarily used for smoothing or deburring. Erosion acceleration systems are used in large scale landscaping to remove sections of hillside. It is further contemplated that various systems may make use of spinning blades at a specific distance from a reference surface, driven by water. These systems may employ various rotary tools used for stone carving, with a variety of attachment heads. Under sidewalk hold digger systems allow the user to remove the dirt from beneath a section of pavement for the purpose of routing cables, etc. The user would then refill the hold without having to replace the pavement. Tile cutter systems of the present invention, may employ a high powered water jet for the cutting of tile instead of the use of a blade. Driveway design systems allow the user to grind designs or textures into their driveway. Flexible arms with a spinning blade attachment at the end of the arms may be employed with these systems. A water driven slitting saw system and other systems such as water driven turbines could drive a variety of spinning blade attachments. Alternatively, systems may employ garbage disposals with water driven blades.

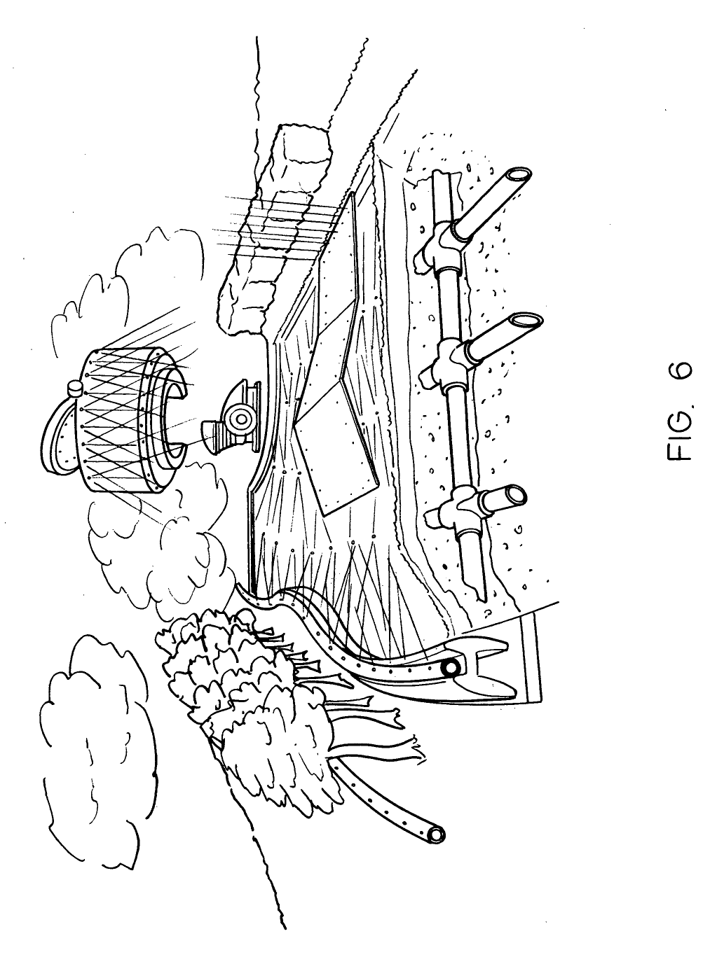

Recreational uses of hydraulic systems, such as the misting system shown in FIG. 6, provide another exemplary embodiment. As shown, the misting system is an in ground system employing a power source coupled with a fluid pump which delivers a fluid, such as water, via underground fluid delivery devices, such as pipes, tubes, and the like, up through a surface and into the immediate environment. The environment, in the present embodiment, is a yard and may include a slip and slide which is coupled with the system and has the fluid running through it. Further, the misting system may be employed for the watering of vegetation, such as plants, vegetables, and the like. A water barrier may be employed to at least partially surround the power source and pump (hydraulic pump system) to aid in limiting noise. The misting system may be employed within a defined environment, such as a greenhouse, to maintain stable environmental conditions or outside to assist in providing a cooler environment or for the watering of vegetation.

In other alternative embodiments, a snow making system, using a misting attachment, freezes the mist coming out and creates snow. Other alternative embodiments include jet scooter systems for use in the pool, wave pool systems, whirpool generator systems, water jet pack systems similar to the water jet scooter, self circling hola hoops, bubble generators, and the like. A highly directional accelerating slip and slide system is further contemplated. Massaging systems where massage columns power a series of massage balls to move randomly within some column structure and the user then leans up against this column for a massage. Lap swimming systems for use in the pool which generate a strong current and train people for river like conditions or increase the challenge of their work out are contemplated by the present invention. Other embodiments include, geyser seat systems, which use a powerful stream of water to lift the user sitting on a platform into the air, power assisted trampoline systems, and water pogo stick systems are encompassed. Water guidance systems which allow a swimmer to avoid hitting the pool edge by creating a current which steers the swimmer away from the edge may be an alternative embodiment of the present invention. Fountain systems, for use as a lawn fountain or art element which could allow the traditional pressure washer to remain in use for more of the year and steam showers, which would heat the water and mist it, creating an in home sauna, are additional contemplated embodiments.

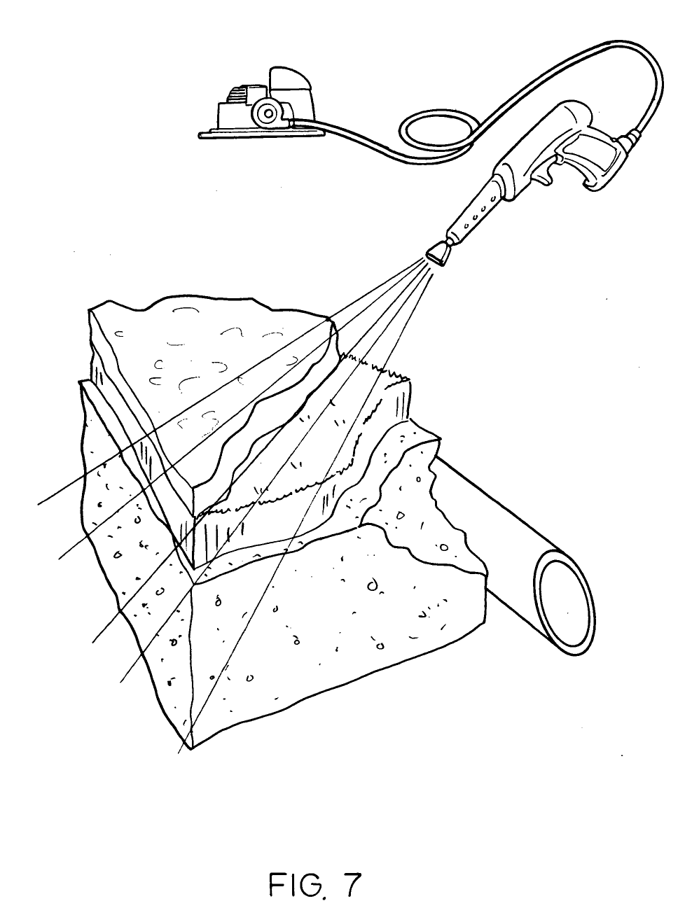

Referring generally now to FIGS. 7 through 12 exemplary embodiments of building or maintenance systems of the present invention are shown.

A lawn aeration and snow removal system is shown in FIG. 7. Utilizing a gun assembly coupled with a hydraulic pump system for delivering a high pressure fluid, the present embodiment may be used to aerate a lawn by boring holes in the surface of the lawn. This may be advantageous in promoting lawn growth and year round health of the lawn. During the winter months, when snow falls on the ground, the present embodiment may be enabled to deliver the high pressure stream of fluid amended with a bio-degradable non toxic freezing point depression solutions, such as a corn based non toxic freezing point depression solution. It is understood that the gun assembly may employ a variety of nozzles and plugs for accomplishing a specific task. Further, the present embodiment may be limited to either a lawn aeration system or a snow removal system.

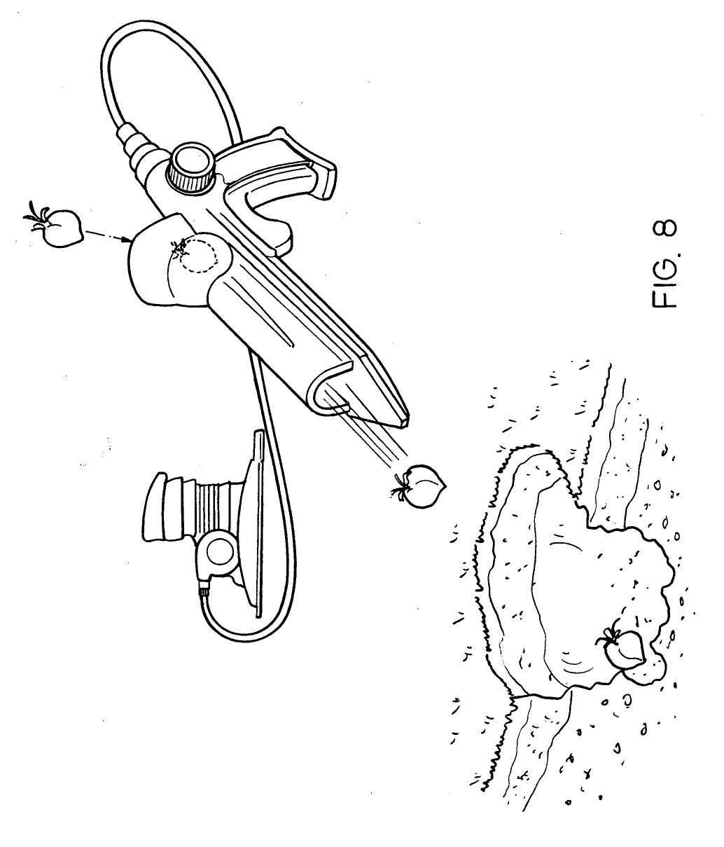

The seed gun system of FIG. 8 operates by using the high pressure fluid, through the gun assembly, to dig a hole quickly, and then seeds or a bulb may be deposited into the hole. It is further contemplated that the present invention may allow for the delivery of a fertilizer after the seeds or bulb is deposited. The gun assembly may be a single, integrated system which includes the delivery mechanism for the high pressure fluid stream and the delivery mechanism for the seeds or bulbs. Such an integrated system may include a selector assembly coupled with the gun assembly for enabling the user of the gun assembly to determine which feature is to be employed. In alternative embodiments, the gun assembly may be a modular system, whereby the high pressure fluid delivery mechanism may be detachably coupled with the seed and bulb delivery mechanism. This modular system may increase the variety of applications which may be accomplished by the present embodiment of the current invention. Further, the gun assembly may couple with a fertilizer delivery mechanism either through a single, integrated unit or as a modular unit as described above for the seed and bulb delivery mechanism. In the integrated gun assembly, the selector assembly may provide for the selection of the fertilizer delivery mechanism as well. The fertilizer may be delivered in various forms, such as in a slurry, which mixes a dry fertilizer with a hydraulic to promote the application of the fertilizer.

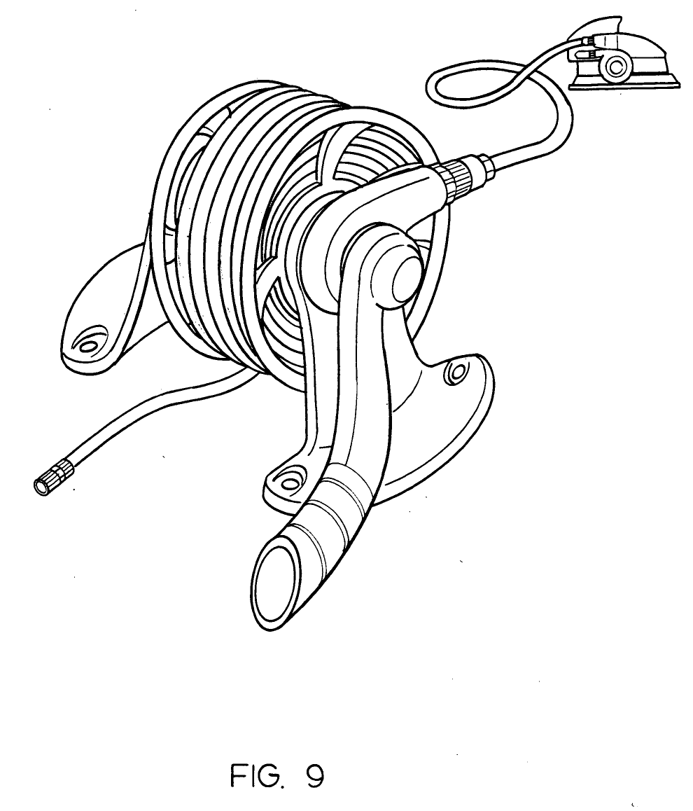

FIG. 9 is an exemplary embodiment of the present invention being employed as a hose winding system. The system may include a stand coupled with a gathering assembly which is enabled to rotate about an axle coupled with the stand. The gathering assembly may be manually turned or through engagement with the hydraulic pump system may be rotated. The hose winding system may include a selector assembly, which may be coupled with the stand, which enables the operator to select between manual or machine operated modes. The size of the hose, stand and gathering assembly may vary to accommodate the needs of the user. An outlet tube may be provided to drain off any excess fluid contained in the hose wound around the gathering assembly. A release mechanism may be included on the hose winding system for allowing the operator to unwind the hose from the gathering assembly.

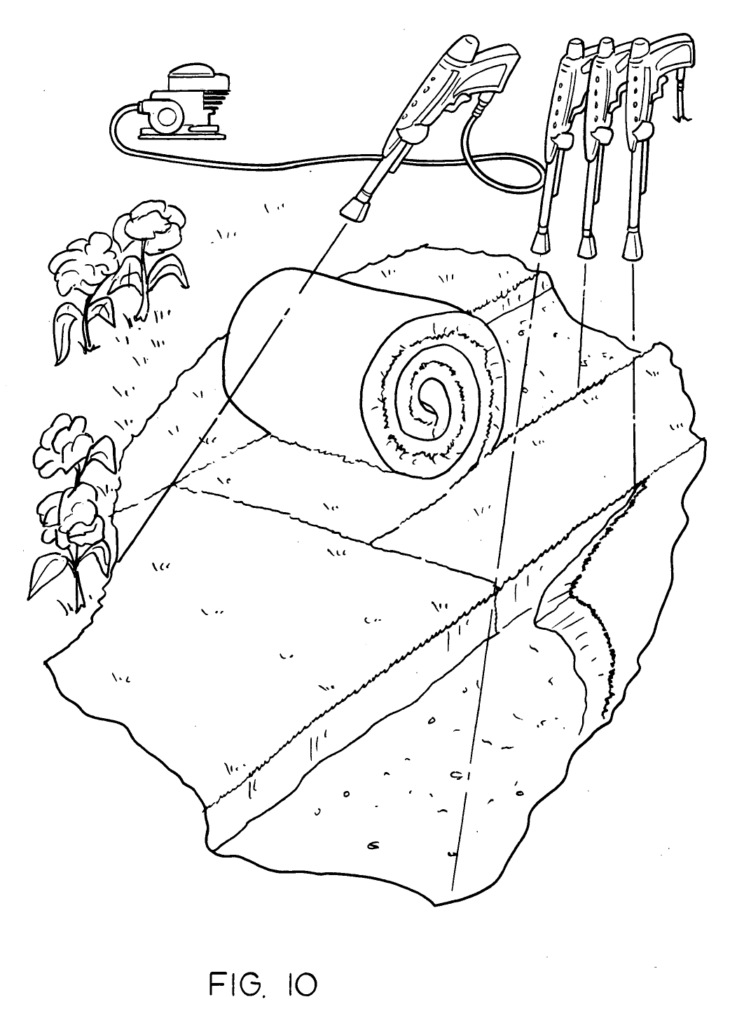

Referring now to FIG. 10, a gardening system is shown. The gardening system may be a gardening kit system employing a gun assembly coupled with a hydraulic pump system to deliver a high pressure fluid stream. The gun assembly may include several attachments, including a sod cutter, a sod edger, a trench digger, a bed shaper, and a bush shaper. These attachments may be inter-changed upon the gun assembly to enable multiple functionalities in the gardening kit system.

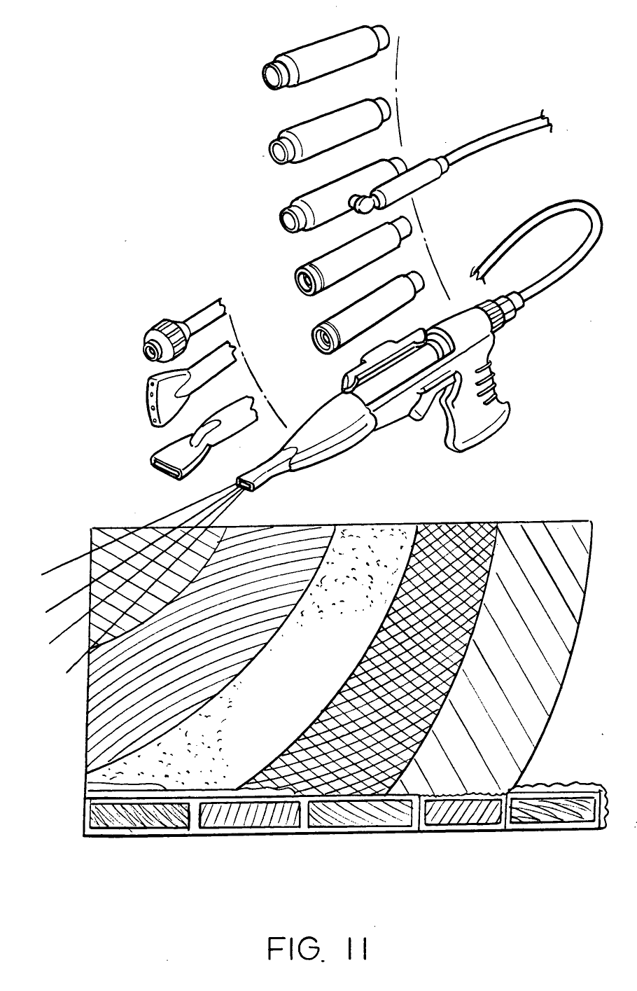

In FIG. 11 a modular cartridge hydraulic system is provided. In the present embodiment a gun assembly is enabled with a cartridge receiver. The gun assembly is connected with a hydraulic pump system (i.e., pressure washer, water jet, and the like) for the delivery of a high pressure fluid stream or a low pressure fluid stream. The cartridge receiver accepts a variety of cartridges. The cartridges may be swapped in and out of the cartridge receiver allowing the user of the gun assembly to use a single gun assembly to accomplish a variety of tasks. The gun assembly may include a wide variety of attachments, such as nozzles and the like. Further, the cartridges may be variously configured to provide a variety of additives, such as soap, grit for abrasion, air cartridges for drying, primer or wood treatment additives, paint or sealant additives, waxes, polishes, and the like.

It is contemplated that the gun assembly may include more than one cartridge receiver. The gun assembly with a plurality of cartridge receivers may utilize the various additives in any combination. For example, a soap cartridge may be employed with a grit cartridge. In operation the grit cartridge may be used to supply grit for the abrading of a surface and the soap cartridge may be used to clean the abraded surface. It is further contemplated that the various additives may be mixed together within the high pressure stream. For example, a sealant and paint may be intermixed within the high pressure stream to provide a dual action application to a surface.

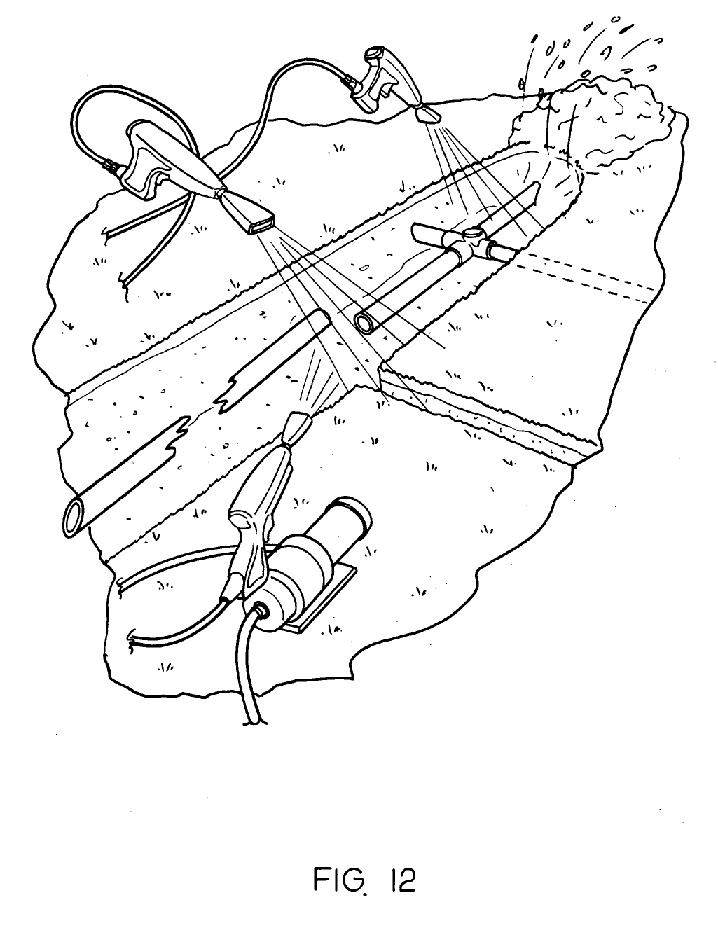

A sprinkler installation system is shown in FIG. 12. The system may include multiple gun assemblies which may couple with one or more compressor assemblies for the delivery of a high pressure fluid stream. The gun assemblies are used to directionally guide the high pressure fluid stream to dig trenches or cut through a surface, i.e., sod, and other various layers of a yard. The gun assemblies may adjust the fluid stream to a low pressure setting for use in cleaning a pipe or other surface where digging or cutting is not required.

In other alternative embodiments, these systems may include a snow sculpture kit system. Fruit harvesting systems allow the user to use a stream of water to dislodge the fruit from high tree branches. This, combined with the catching basket, allow harvesters to avoid the use of ladders or additional picking equipment. Other alternative embodiments include water driven screwdrivers, lawn mowers/mulchers, very fast gas filling systems, hydraulic trash compactor systems, post hole diggers, water pressure concrete mixers, hydraulic hammers, wall paper flattening devices, deck kits which provide the ability to repair cuts, wash a deck, stain a deck, and the like. Surface feature creation kit systems are contemplated, which change the blast pattern/intensity wherein the user is enabled to create cool surface features in materials such as bowls, surface profiles, etc. Weed removal systems which blast weeds out with a high pressure stream of water. Leaf blower systems which use water, not air. Stone masonry kit systems with different bits which allow the user to create different effects in the stone. Jigsaw system of pavers wherein the pavers are put down first and then cut creatively in situ. Compost sorting systems which push yard debris through a series of screens and sort the debris into like-sized bins. Hydraulic systems that assist the user in moving a tool (power assisted). Area levelers which use the force of water to redistribute gravel or a particulate over an area. Compost compactors which crush yard debris down into small, denser blocks, making storage and disposal easier. Flooding the area around an existing machine tool allows the cutting of toxic materials and water wicks away harmful fumes or air particulates. Nail removal systems, which push the nails out of wood. No waste concrete mixer systems, which allow the user to put in water and dry concrete and the machine mixes the dry concrete in real time. Un-used ingredients are not mixed and easily stored. Nozzles which allow the user to select hot or cold water, grit or other additives may be employed with the systems described above.

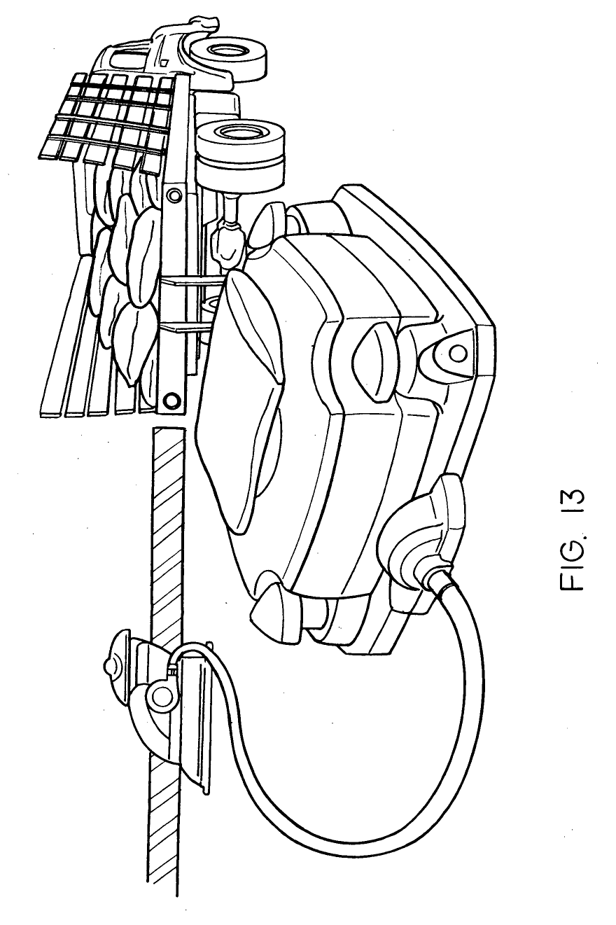

Referring generally now to FIG. 13, the present invention may employ a five horsepower engine providing added power and functionality. One of those functionalities is shown in FIG. 13, where the present embodiment shows a hydraulic lift system. The hydraulic lift system includes a stand which operationally couples with a bladder. The stand includes comers which direct the motion of the bladder, as it fills with fluid, upwards. The inflating bladder, which is a water pressurized bladder, provides the lifting force which engages against an object to be lifted. It is contemplated that the stand may be enabled to operationally engage with variously sized bladders. The stand may be adjustable in order to accommodate the differently sized bladders, or there may be a variety of differently sized stands to engage with the differently sized bladders.

In other embodiments, a powered wheel barrow systems including a hoist dump, lifts for heavy materials, and assistance in rolling and braking systems is disclosed. Vacuum systems, used as a garden vac, with the bag then being funneled into a composter or garbage heap are contemplated. Yard drilling systems wherein one end is placed in a pre-drilled hole, with an arm at a certain distance from the end, and the drill on the end of this arm. The first hole acts as the counter force, allowing the drill to drill the second hole. This fixture then allows the drilling of a line of holes at even spacing. A laser line follower may be incorporated. Other alternative embodiments include chippers, hydraulic lifts using an inflating bladder, floor sanders, hedge levelers, go carts, concrete brushes, driveway sealing systems, powerful professional grade carpet cleaners, sump pumps, hardwood floor cleaners, and the like. Slow high torque trench digging systems may be provided using the technology of the present invention. The motion may be controlled, thus the user may not even need to be involved and could walk away and do other things while the digger operates. Other contemplated embodiments include, tillers, with built-in soil amendment features which add compost and water, and tamping systems, for gravel which would effectively vibrate on the ground to flatten and push gravel into place. Additional embodiments may include, fast whole house evacuation fan systems, driven by the motor from a special mounting position on the roof, vent evacuation systems, wherein the motor is used to drive a powerful vacuum that is able to remove dirt and dust from a ventilation system, jacks, for picking up or moving heavy items, and power assisted lift systems, for lowering things into and out of a truck bed.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A pressure washer, comprising:
a pump connected with an engine;
a fluid transfer device connected to the pump, the fluid transfer device allowing the pump to drive fluid through it;
a gun including a cartridge receiver, the gun connected to the fluid transfer device, the gun for directing the expelling of the fluid received through the fluid transfer device;
a cartridge connected with the cartridge receiver of the gun, the cartridge for providing an additive to the flow of fluid being expelled from the gun.

2. The pressure washer of claim 1, wherein the cartridge may be removed from the cartridge receiver of the gun and a secondary cartridge connected with the cartridge receiver.

3. The pressure washer of claim 1, wherein the gun is capable of being utilized with a high pressure and low pressure fluid stream.

4. The pressure washer of claim 1, wherein a high pressure nozzle is connected with the gun.

5. The pressure washer of claim 1, wherein a high pressure blade attachment is connected with the gun.

6. The pressure washer of claim 1, wherein the additive includes at least one of a soap, grit for abrasion, air for drying, primer, wood treatment, paint, wax, polish, and sealant.

7. The pressure washer of claim 1, wherein the additive is seed for planting.

8. The pressure washer of claim 1, wherein the gun is included in a marine cleaning system.

9. The pressure washer of claim 1, wherein the gun is included in a gardening system.

10. The pressure washer of claim 1, wherein the gun is a finishing tool for providing a finish to a workpiece.

11. The pressure washer of claim 1, wherein the gun is included in sprinkler installation system.

12. A pressure washer, comprising:
a pump connected with an engine;
a fluid transfer device connected to the pump, the fluid transfer device allowing the pump to drive fluid through it;
a nozzle connected with the fluid transfer device, the nozzle for directing the flow of the fluid; and
a high pressure blade attachment connected to the nozzle, the high pressure blade attachment for cleaning blockage from a pipe.

13. The pressure washer of claim 12, wherein the nozzle is included in a hydraulic lift system.

14. The pressure washer of claim 12, wherein the nozzle is included in a composting machine.

15. The pressure washer of claim 12, wherein the nozzle is included in a polishing system.

16. The pressure washer of claim 12, wherein the nozzle is included in a snow making system.

17. The pressure washer of claim 12, wherein the nozzle is included in a massage system.

18. The pressure washer of claim 12, wherein the nozzle is included in a fountain system.

19. The pressure washer of claim 12, wherein the nozzle is included in a water guidance system.

20. The pressure washer of claim 12, wherein the nozzle is included in a hose winding system.
